(19) United States
(12) Patent Application Publication
(10) Pub. No.: US 2009/0098322 A1
(43) Pub. Date: Apr. 16, 2009

(54) PVC reinforced furniture and building components

(76) Inventor: Peter J. Luciani, JR., Stratham, NH (US)

Correspondence Address: ROBERT K. TENDLER, 65 ATLANTIC AVENUE, BOSTON, MA, 02110, US

(21) Appl. No.: 11/974,639

(22) Filed: Oct. 15, 2007

(51) Int. Cl. B32B 1/08; B32B 37/12

(52) U.S. Cl. 428/35.7; 156/60

(57) ABSTRACT

PVC furniture or building components are formed by surrounding a structural support such as aluminum pipe with non-structural PVC elements, with the PVC elements optionally sculpted for decorative purposes.

### FIELD OF THE INVENTION

This invention relates to furniture and more particularly to furniture made from a non-structural material such as PVC that is reinforced with a structural material such as aluminum, the resulting furniture taking on the pleasing look of sculptured wood while at the same time being made from durable polyvinyl chloride.

### BACKGROUND OF THE INVENTION

Wood has been the favored material for furniture designs primarily due to the ability to sculpt the wood to provide a pleasing and/or decorative design as well as its structural rigidity such that the furniture made from wood that will not collapse or deform under its own weight, and which can bear the weight of an individual or other heavy objects placed thereon.

In the past, furniture has been made of PVC pipe which because of its tubular configuration leads to structural rigidity not found in a flat PVC sheet.

Flat PVC sheet comes in a variety of thicknesses but does not have the structural strength to withstand bending, even when supported at its periphery or ends. However, PVC is considerably more durable than wood and does not require finishing such as wood which requires varnish, staining, shellac and/or paint to withstand the elements. The result is that PVC sheet stock has not been employed for furniture products such as tables, chairs, benches and the like.

Not only is the non-structural characteristic of PVC sheet been problematic for furniture, it is also impractical for building components such as pergolas, columns, and other building components, be they ornamental or structural.

Wood on the other hand has been used for all of these components but requires treatment or staining/exterior coatings, especially when used out of doors and subjected to the elements. Whether used for furniture or building components, weathering and thermal expansion and contraction problems have required refinishing of such objects at regular intervals. Since the finishes or paints deteriorate over time due to UV, rain, snow, ice and airborne particulate matter that can cause erosion, it would be particularly useful if PVC could be manufactured in pleasing configurations, in essence to be a substitute for wood due to its virtual indestructibility. Also, PVC has not been utilized for decorative components because it was not generally recognized that PVC could be carved or sculpted.

### SUMMARY OF INVENTION

Rather than using sculpted wood for furniture and building components, in the subject invention a reinforcing member is wrapped with or surrounded by polyvinyl chloride. In one embodiment, flexible PVC sheet is configured to a pleasing or decorative appearance either through routing, sculpting, molding, carving or cutting, with the PVC pieces being put together to surround the reinforcing member in such a way that the outer PVC portions of a furniture element wrap or surround the reinforcing member. When completed the result is a furniture element having a pleasing appearance formed by the shape of individual parts that provide the final structural furniture or building component.

By itself PVC alone will not provide a suitable furniture element or building component element due to the flexibility of the PVC element and the fact that it is not considered to be a structural material. A structural material as defined herein is one that is self-supporting without bending and that does not significantly bend upon the application of loads, short of catastrophic failure.

In the subject invention each of the PVC furniture elements or components is reinforced with an internal structural member made in one embodiment of aluminum, with the aluminum being wrapped or surrounded by the sculpted PVC parts that make up the finished element.

In one embodiment the elements that surround the aluminum part are adhesively attached to the aluminum part with adhesive such as Bond & Fill™ Flex and Devcon TrimBonder™, described in detail hereinafter. Even though aluminum has a thermal coefficient of expansion of 24×10⁻⁶ α (1/° C.), and wherein PVC has a thermal coefficient of expansion 3.0×10⁻⁵ α (1/° C.), an order of magnitude difference, it has been found that with the thermal cycling of the type that outside furniture and components are subjected to, there is no cracking, crazing or deformations that would make the structural component unusable, be it in furniture or as part of a building component.

The result is that one can make outdoor furniture or outdoor building components of PVC-wrapped aluminum and make the components of a pleasing design without having to resort to carved, routed or otherwise-formed wooden objects.

One therefore has an extremely durable piece of furniture or exterior component that can stand up to the weather and not noticeably deteriorate over tens of years as opposed to wood products that must be repainted, re-varnished or re-treated, sometimes on a yearly basis.

While the subject invention describes the utilization of aluminum, which is lightweight, other structural materials including other metals or composites for the strengthening or reinforcing of such PVC-wrapped members are within the scope of the subject invention.

In short, PVC structural furniture lasts forever, will not check nor splinter, nor collect bacteria. Because it is structural, it provides for decorative furniture and building components that now no longer need to be made out of wood or materials that require constant upkeep.

In one embodiment the structural reinforcing material is an aluminum rectilinear tube that provides four surfaces for the bonding of the wrapped PVC thereto.

In summary, PVC furniture or building components are formed by surrounding a structural support such as aluminum pipe with non-structural PVC elements, with the PVC elements optionally sculpted for decorative purposes.

### BRIEF DESCRIPTION OF THE DRAWINGS

These and other features of the subject invention will be better understood in connection with the Detailed Description, in conjunction with the Drawings, of which:

FIG. 1A is a diagrammatic illustration of a PVC table having decorative elements such as a table leg formed with PVC sheets, which are adhered to an internal reinforcing member, in one embodiment a rectilinear aluminum pipe, to provide the required structural rigidity for the table leg;

FIG. 1B is a diagrammatic illustration of the table of FIG. 1A in which the internal reinforcing member for a leg is wrapped with four PVC flat sections that have been cut to provide for the decorative exterior of the leg;

FIG. 2 is a diagrammatic illustration of a picnic table having reinforced PVC legs, a PVC-wrapped frame for the table top that would otherwise sag and a reinforcing member for a PVC seat;

FIG. 3 is a diagrammatic illustration of the position of reinforcing members which are to be wrapped by the decorative PVC facing to provide the pleasing outward appearance of the leg and frame structure for the table of FIG. 2;

FIG. 4 is a diagrammatic illustration of one method of wrapping the reinforcing members of FIGS. 1-3, in which the reinforcing member is sandwiched between two PVC sheets, with each sheet having the appropriate channels routed out so as to permit the sandwiching of the internal reinforcing member therebetween, also showing the utilization of a number of PVC plies, with one of the plies being cut so as to provide for the routed-out structure;

FIG. 5 is a diagrammatic illustration of the completion of the element of FIG. 4 through the laying of the reinforcing member within the channel formed for a bottom PVC sheet;

FIG. 6 is a diagrammatic illustration of the completed PVC-wrapped reinforced article;

FIG. 7 is a plan view of one face of the article of FIG. 6 showing the position of the reinforcing member in dotted outline;

FIG. 8 is a cross-sectional view of the article of FIG. 7 indicating the wrapping of the reinforcing member with the PVC;

FIG. 9 is a diagrammatic illustration of a bench seat made out of PVC in which the PVC making up the bench seat is reinforced with an internal reinforcing member to prevent the seat from sagging;

FIG. 10 is a diagrammatic illustration of the seat of FIG. 9, showing the reinforcing member in dotted outline underneath the seat;

FIG. 11 is a diagrammatic illustration of the fabrication of a pergola utilizing the subject reinforced PVC technique; and,

FIG. 12 is a diagrammatic illustration of the completed FIG. 11 pergola.

### DETAILED DESCRIPTION

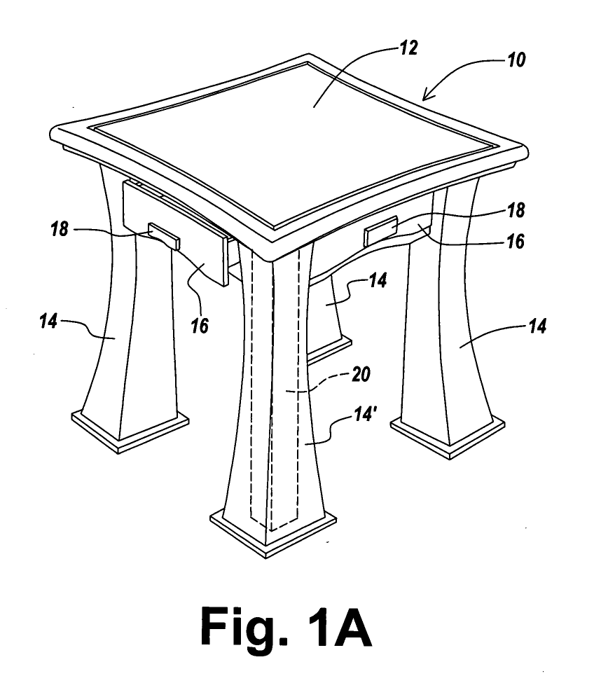

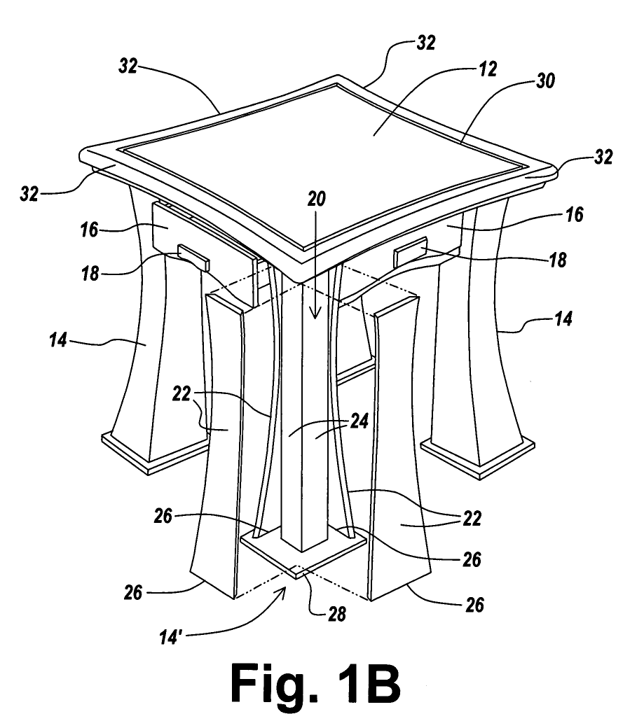

Referring now to FIG. 1, an article of furniture, namely a table 10, is shown constructed of a sculpted PVC table top 12 and stylistic legs 14, also made of polyvinyl chloride. The table includes PVC drawer 16 with PVC drawer pulls 18, with the elongate members of the table, namely tabletop 12 and legs 14, being made of sculptured PVC and reinforced, at least in terms of leg 14′, with an internal reinforcing member 20, in one embodiment a rectilinear aluminum tube which is internally carried in leg 14′.

While not described in this figure, the table top is also provided with aluminum reinforcing as will be described hereinafter.

Referring to FIG. 1B, leg 14; is constructed so as to have sheet or facing members 22 arranged about and secured to the flat sides 24 of reinforcing member 20, with the lower edges 26 of each of sheets 22 being fixedly attached to a base 28 to complete the structural leg.

The face sheets or members 22 of the leg are joined together through adhesive attachment not only to base 28 and to the underside of table top 12 but also are adhesively adhered at least at certain positions to faces 24 of reinforcing member 20.

What will be appreciated is that the shape of the leg is determined by the wrapping of the reinforcing member by the preformed sheets 28 having edges that are curved and that have a body that may also be bowed inwardly as illustrated.

What will be appreciated from FIGS. 1A and 1B is that a complete PVC table having a pleasing and decorative appearance from the sculptured PVC is provided with sufficient structural rigidity to make the PVC a structural material capable of supporting not only its own weight, but any loads imparted to the table.

It will also be appreciated that other decorative members such as the facing on door 16 or the door pull 18 can be easily effectuated by the sculpting of PVC elements.

Finally it will be appreciated that table top 12 may be routed to provide a detail 30 within the table top and may have curved edges 32, again to give a designer-type pleasing appearance to the table top itself.

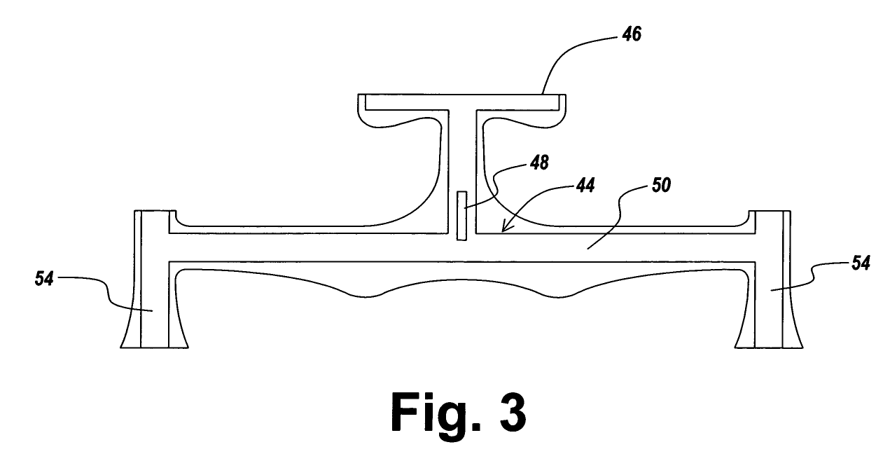

As will be described, the table top is reinforced by an underlying aluminum frame to be more completely described in connection with FIGS. 3, 9 and 10.

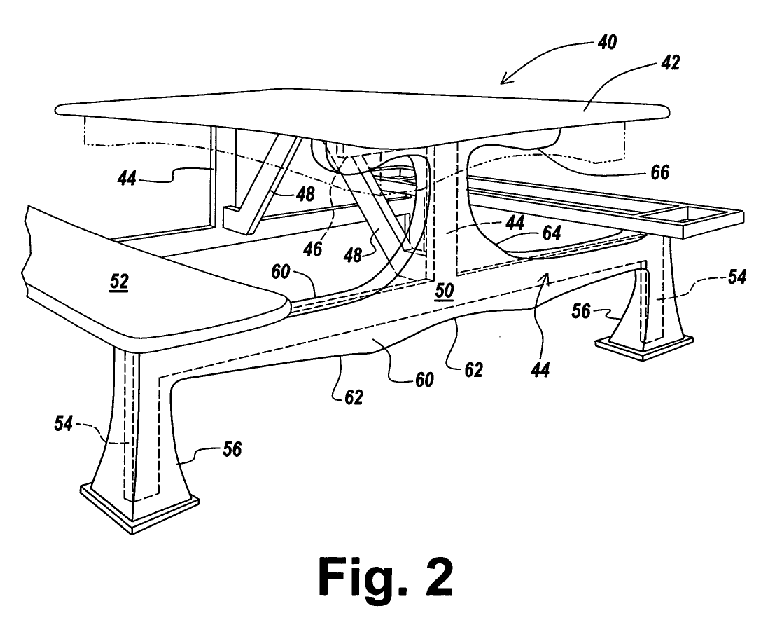

Referring now to FIG. 2, the subject technique may be applied to a picnic table 40 having a table top 42 positioned atop an aluminum frame reinforcing member 44, which has a laterally extending table top supporting portion 46 as illustrated.

Reinforcing member 44 also has brace members 48 that extend upwardly from a juncture at the base of member 44 where it meets a laterally extending portion 50 to support the table top.

Of note is the utilization of the reinforcing member 44 to form the lateral portion of the frame, atop which are mounted benches or seats 52, with a downwardly extending portion 54 of reinforcing frame 44 serving as reinforcement for legs 56 formed as illustrated in FIGS. 1A and 1B.

It will be appreciated that the legs and frame are wrapped with PVC sheets 60 that sandwich the reinforcing members/frame 44 therebetween. Also as can be seen, sheet 60 may be provided with arcuate details 62 to provide a pleasing appearance for the picnic table.

Sheets 60 extend not only laterally to show the detail 62 but also extend upwardly as shown at 64 and outwardly again at 66 to complete the exteriorly viewable design of the picnic table.

Referring now to FIG. 3, what can be seen is the placement of the reinforcing member 44 and its various components to be wrapped with or shrouded by sculptured PVC sheets or faces.

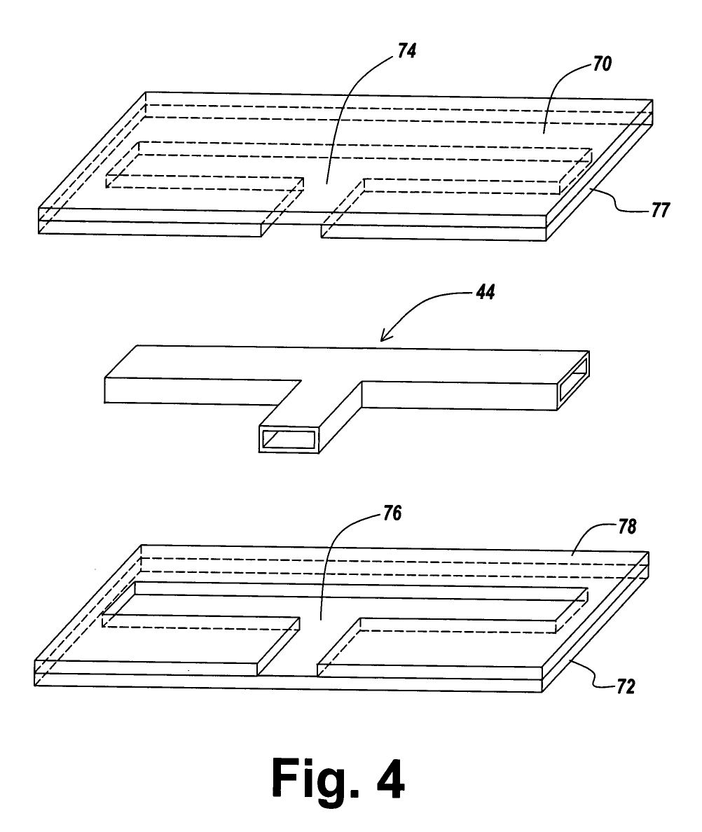

Referring now to FIG. 4, in an exploded view, the sandwiching of the reinforcing member 44 between sheets 70 and 72 is illustrated, with sheets 70 and 72 being provided with a routed out portion 74 and 76 respectively to accommodate reinforcing member 44.

In one embodiment the routed out portion may be provided through a two-ply lamination in which a preformed and precut sheet 77 with respect to sheet 70 and 78 with respect to sheet 72, these sheets being laminated to the respective sheets to provide an opening into which the reinforcing member may be embedded

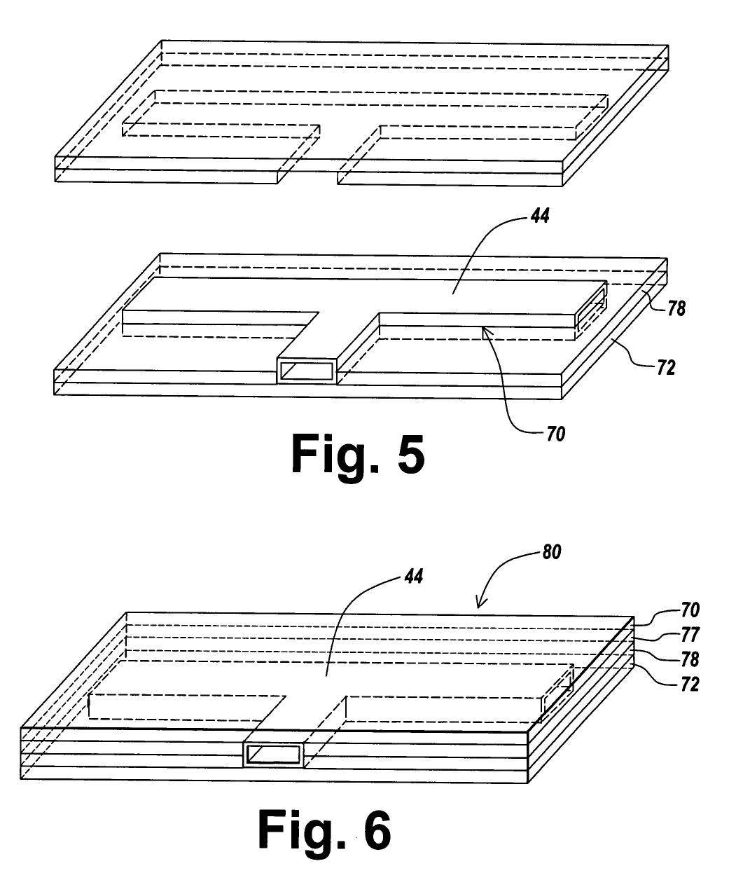

Referring now to FIG. 5, it can be seen that reinforcing member 44 is placed within routed out portions 76 in the bottom sheet 78, whereas the completed wrapped article is shown in FIG. 6 in which the reinforcing member 44 is shown embedded within the laminated ply structure here diagrammatically illustrated at 80.

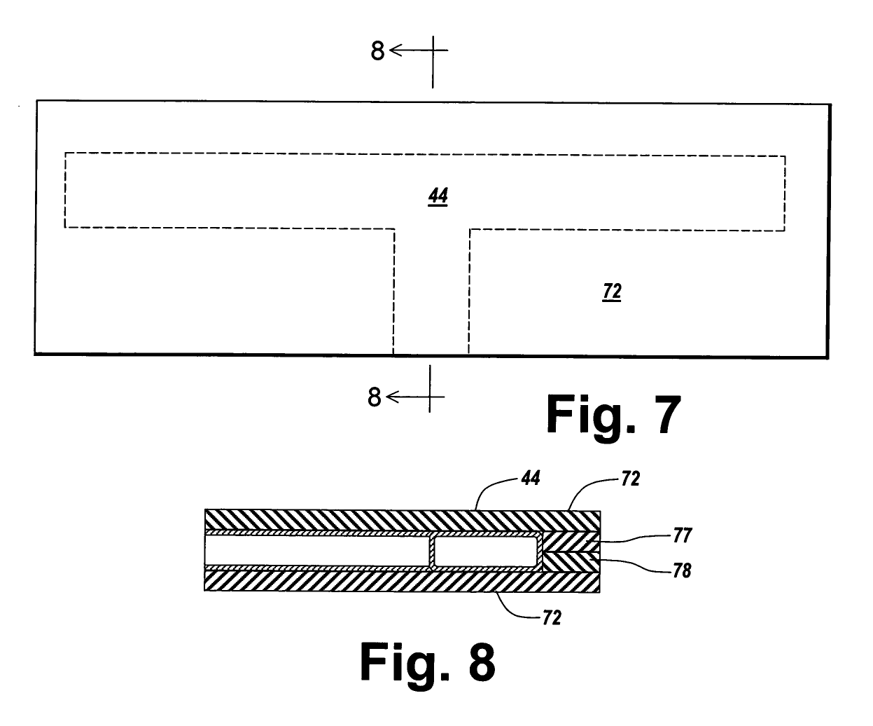

More particularly as shown in FIG. 7, the reinforcing member 44 is shown in dotted outline for the plan view of sheet 72, which in this cross-section in FIG. 8 shows reinforcing member 44 sandwiched between sheets 70 and 72, showing also the laminated structure of interior sheets 77 and 78.

What will be appreciated is that the reinforcing member, in one instance rectilinear aluminum tube, may be embedded into a final polyvinyl chloride element to provide sufficient structural rigidity thereto to make the element a structural element as opposed to a non-structural element.

The polyvinyl chloride sheets may be adhered to, for instance, an aluminum reinforcing member utilizing Bond & Fill™ Flex adhesive. Bond & Fill™ Flex from Bond & Fill of East Taunton, Mass. is an acrylic adhesive whose resin has the following composition: Methyl Methacrylate (MMA); Cumene Hydroperoxide; p-toulenesulfonyl; and Methacrylic Acid. The activator contains Methyl Methacrylate (MMA) and Amine Condensate. Another suitable adhesive is TrimBonder™, manufactured by the Devcon Division of ITW in Danvers, Mass. It is an acrylate adhesive having the following composition: Diisodecyl phthalate; Methacrylic Acid (MMA); and Methyl Methacrylate Monomer (MMA).

It has been found that regardless of the difference in thermal coefficients of the two materials, the completed structure withstands temperature ranges between −10° F. to 120° F.

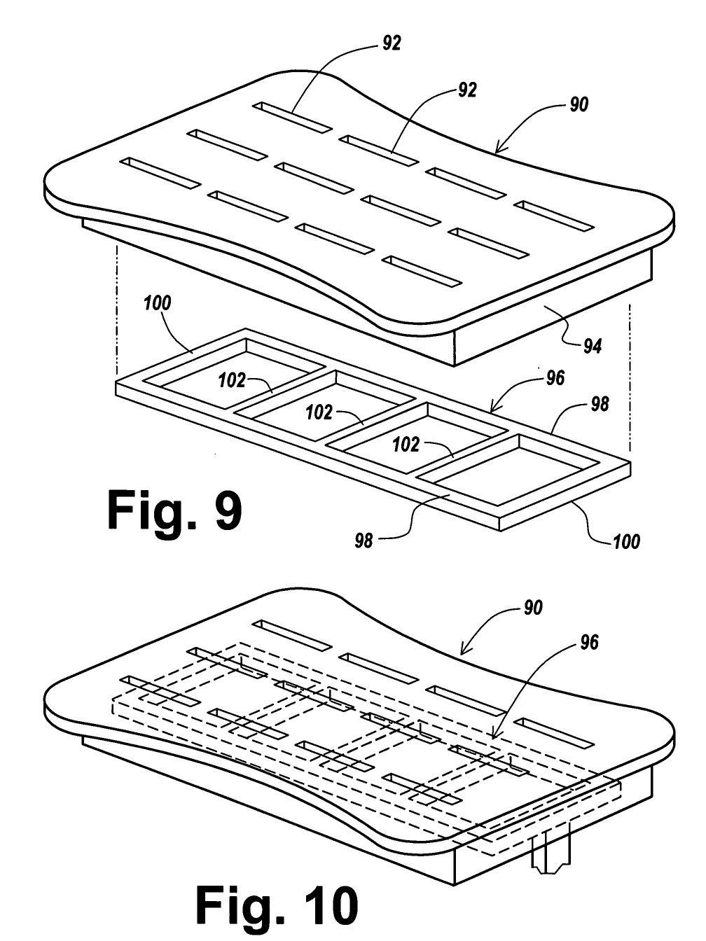

Referring now to FIG. 9, what is shown is a sculptural PVC bench seat 90 having apertures 92 precut therein and showing a PVC reinforcing member frame 94 that exists at the periphery of seat 90.

Here it can be seen that seat 90, rather than being rectilinear, has been provided with curves such that the visual top surface of the seat has a pleasing appearance.

Were the seat to be formed without reinforcement through the utilization of a reinforcing member, here illustrated at 96, then the seat would sag under its own weight and certainly would not be able to support an individual sitting thereon.

Here the reinforcing member 96 is made out of rectilinear frame parts having sides 98 and end pieces 100 with intermediate braces 102 being provided down the length of the reinforcing member. How this is put together is shown in FIG. 10 in which seat 90 is supported by the internal reinforcing member 96 shown in dotted outline.

While the above has been illustrated in terms of providing a notch or routed-out portion of a PVC facing sheet, the internal routed out or notched portion may be provided by using the sheet lamination process described hereinbefore.

Moreover, while rectilinear aluminum tubing is a preferred embodiment for the reinforcing member, reinforcing members of any other type of metal or composite material may be utilized to convert what would normally be a non-structural polyvinyl chloride member into a structural polyvinyl chloride member.

Referring now to FIG. 11, a decorative building element such as a pergola 120 may be formed out of a sheet 122 of PVC such that the decorative appearance of the pergola is achieved by cutting the sheet along the curved line 124. The pergola is meant to be reinforced by a reinforcing member 126 such as the T-shaped member shown, which is constructed such that the PVC sheets are provided with the routed out or notched interior to accommodate the reinforcing member.

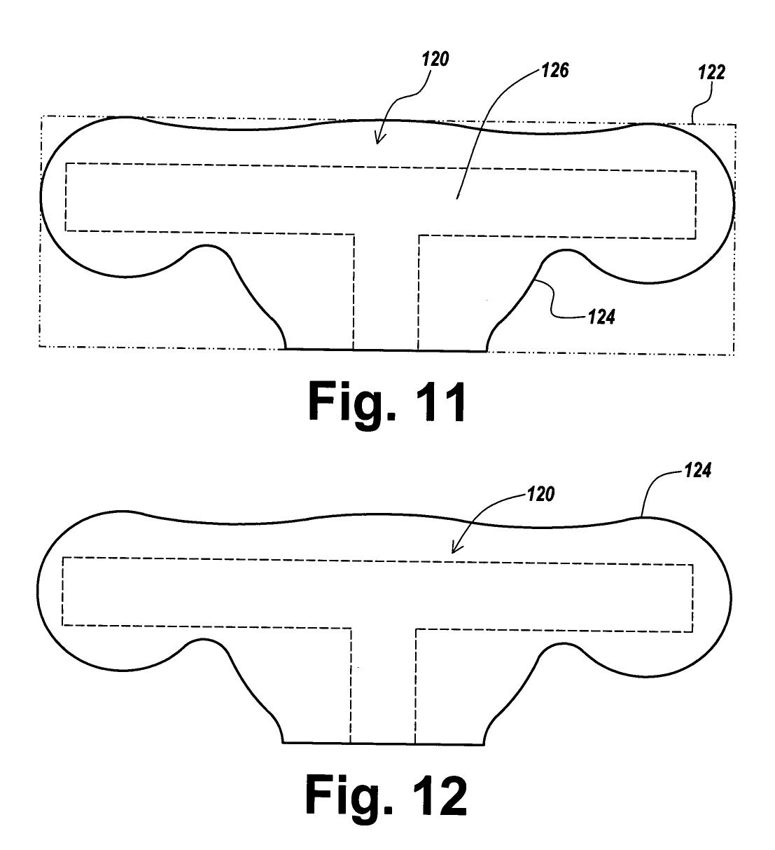

The finished product as illustrated in FIG. 12 is includes pergola 120 having the decorative appearance formed by the scribe or cut line 124 so as to provide a building element that is both structurally sound and decoratively pleasing.

This building element may be constructed in the manner shown in FIGS. 4 through 8, with the invention not being limited to PVC furniture but also including decorative PVC building elements.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. A PVC furniture element, comprising:
a reinforcing member; and,
PVC sheet elements wrapped around and surrounding said reinforcing member, said PVC sheets adhered to said reinforcing member with adhesive, thereby to provide a PVC furniture element with enough structural rigidity to make said furniture element a structural element.

2. The apparatus of claim 1, wherein said PVC element includes PVC sheet material and wherein said reinforcing member is tubular.

3. The apparatus of claim 2, wherein said tubular reinforcing member has a rectilinear cross section.

4. The apparatus of claim 1, wherein said PVC sheet is sculpted and by cutting said sheet into a predetermined shape.

5. The apparatus of claim 3, wherein said sculpted PVC sheet is formed through routing the surface of said sheet to provide a predetermined appearance.

6. The apparatus of claim 3, wherein said sculpted PVC sheet is formed through carving.

7. The apparatus of claim 1, and further including adhesive for bonding said PVC element to said reinforcing member.

8. The apparatus of claim 7, wherein said reinforcing member includes aluminum, and wherein said adhesive is taken from the group consisting of Bond & Fill™ Flex and Devcon TrimBonder™.

9. (canceled)

10. The method of claim 1, wherein the structural furniture element is made by surrounding a reinforcing member with PVC material, thereby to wrap the reinforcing member, whereby the furniture element utilizes non-structural material, made structural by the introduction of a reinforcing member adhesively adhered to the PVC material.

11. (canceled)

12. The method of claim 10, wherein the reinforcing member is housed internally to the structural furniture element.

13. (canceled)

14. The method of claim 1, wherein the PVC material includes a flat PVC sheet.

15. The method of claim 14, wherein the flat PVC sheet is sculpted to provide a predetermined appearance for the furniture element.

16. The method of claim 15, wherein the sculpting is taken from the group of sculpting processes consisting of routing, cutting, molding, scoring, and carving.

17. A PVC building component for use in building construction, comprising:
a reinforcing member;
non-extruded PVC elements wrapped around and surrounding said reinforcing member such that said reinforcing member is in at least in part adhesively attached to said wrapped PVC elements, thereby to provide a PVC building component capable of withstanding temperature extremes and with enough structural rigidity to make said PVC component structural, said reinforcing member being made of aluminum; and,
an adhesive which welds adhesively attached said aluminum to said PVC elements.

18. The apparatus of claim 17, wherein at least one of said PVC elements is sculpted to form a decorative element.

19. The apparatus of claim 18, wherein said sculpted PVC element includes forming said element by cutting PVC sheet into a predetermined shape.

20. The apparatus of claim 18, wherein said sculpted PVC element is formed through routing the surface of PVC sheet to provide a predetermined appearance.

21. The apparatus of claim 18, wherein said sculpted PVC element is formed through carving.

22. (canceled)

23. The apparatus of claim 1 wherein said adhesive is taken from the group consisting of Bond & Fill™ Flex and Devcon TrimBonder™.
